(19) United States
(12) Patent Application Publication
(10) Pub. No.: US 2012/0201387 A1
(43) Pub. Date: Aug. 9, 2012

(54) FM RADIO RECEIVING APPARATUS

(76) Inventors: Yuji Matsuda, Tokyo (JP); Tatsuya Obata, Tokyo (JP)

(21) Appl. No.: 13/501,441

(22) PCT Filed: Feb. 15, 2010
(86) PCT No.: PCT/JP2010/000904

§ 371 Date: Apr. 11, 2012

(51) Int. Cl. H04H 40/45

(52) U.S. Cl. 381/3

(57) ABSTRACT

An FM radio receiving apparatus includes a stereo decoder unit 301 for separating a stereo signal of a received FM stereo broadcasting wave into voice signals of individual channels, a binarization processing unit 302 for binarizing the individual voice signals of the channels separated by the stereo decoder unit, and a correlation deciding unit 303 for storing the voice signals of the individual channels binarized by the binarization processing unit 302 for a prescribed time period, and for deciding correlation from the voice signals of the individual channels stored, and the FM radio receiving apparatus controls the degree of separation of the individual channels of the stereo signal in accordance with the correlation decided by the correlation deciding unit 303.

### TECHNICAL FIELD

The present invention relates to an FM radio receiving apparatus that detects correlation between channels of an FM (Frequency Modulation) stereo broadcasting wave received and controls the degree of separation of stereo signals.

### BACKGROUND ART

If multipath distortion occurs when receiving an FM broadcast by an onboard FM radio receiving apparatus, the stereo pilot signal is affected by the distortion, which will give rise to undesirable effects called “stereo distortion” that will prevent achieving correct stereo separation. As for the stereo distortion, it is known conventionally that converting the stereo signals to a monaural signal is effective. More specifically, effective suppression of the stereo distortion is achieved by controlling the separation of the right and left signals in accordance with a state of occurrence of noise by maintaining the quality of sound by suppressing monauralization when presence of stereo is good with a wide spreading feeling of right and left sound fields, but by carrying out monauralization positively when presence of stereo is not good with a narrow spreading feeling of the right and left sound fields.

When a radio wave environment deteriorates which varies moment by moment with movement, the onboard FM radio receiving apparatus described above carries out control of limiting the degree of stereo separation described above in order to suppress the stereo distortion. Although the control of limiting the degree of stereo separation is effective to suppress the stereo distortion, it has a problem in the quality of sound of deteriorating presence of right and left. Thus, as for the suppression of the stereo distortion and the state with or without the presence, there is a trade-off relationship between them. Accordingly, it is necessary for the onboard FM radio receiving apparatus to perform appropriate control for adjusting the balance between the suppression of the stereo distortion and presence of stereo in accordance with the radio wave environment.

Conventionally, a technique has been known which detects correlation between channels of an FM stereo broadcasting wave, and controls the degree of stereo separation and the quality of sound in accordance with the correlation value detected. According to the technique, it can carry out noise suppression while weakening the limit of the degree of stereo separation for contents such as music that require high quality of sound with good presence of stereo, and while strengthening the limit of the degree of separation for contents such as news that do not require so muchpresence of stereo as music (see Patent Document 1, for example).

According to the technique disclosed in the Patent Document 1 described above, it receives an FM stereo broadcasting wave and generates a sum signal and a difference signal from voice signals after the stereo separation, and detects the correlation between channels by detecting the levels of the two signals. In addition, as for the correlation detecting processing between channels, it is necessary to carry it out for a rather long period to avoid an uncomfortable feeling due to frequent changes of the degree of stereo separation. However, according to the technique disclosed in the Patent Document 1, it has a problem of requiring a large memory because it performs the correlation detection using the signal levels.

The present invention is implemented to solve the foregoing problems. Therefore it is an object of the present invention to provide an FM radio receiving apparatus capable of achieving appropriate control for adjusting the balance between the suppression of stereo noise and presence of stereo while reducing the memory capacity required for the correlation detection processing at the control of the degree of stereo separation.

### PRIOR ART DOCUMENT

### Patent Document

Patent Document 1: Japanese Patent Document Laid-Open No. 8-178673/1996.

### DISCLOSURE OF THE INVENTION

The present invention, which relates to an FM radio receiving apparatus that detects correlation between channels in an FM stereo broadcasting wave and carries out control for limiting the degree of separation of a stereo signal, comprises a stereo decoder unit for separating the stereo signal into voice signals of individual channels, a binarization processing unit for binarizing the individual voice signals of the channels separated by the stereo decoder unit, and a correlation deciding unit for storing the voice signals of the individual channels binarized by the binarization processing unit for a prescribed time period, and for deciding correlation from the voice signals of the individual channels stored.

According to the present invention, the correlation deciding unit stores the binarized voice signals of the individual channels for the prescribed time period and decides the correlation from the voice signals of the individual channels stored. As a result, it can suppress an undesirable effect of impairing presence of stereo by placing a stronger limit on the degree of stereo separation as the correlation between channels increases, for example. In addition, since the correlation deciding unit makes the correlation decision after storing the binarized voice signals of the individual channels after the stereo separation for the prescribed time period, it can reduce the memory capacity required for the storage of the stereo signal and increase the accuracy of the correlation detection as compared with the conventional example that makes the correlation decision by comparing the levels of the voice signals of the individual channels stored for a prescribed time period.

### BRIEF DESCRIPTION OF THE DRAWINGS

FIG. 1 is a block diagram showing a configuration of an FM radio receiving apparatus of an embodiment 1 in accordance with the present invention;

FIG. 2 is a flowchart showing a control operation of the degree of stereo separation of the FM radio receiving apparatus of the embodiment 1 in accordance with the present invention;

FIG. 3 is a block diagram showing a configuration of an FM radio receiving apparatus of an embodiment 2 in accordance with the present invention;

FIG. 4 is a block diagram showing a configuration of an FM radio receiving apparatus of an embodiment 3 in accordance with the present invention;

FIG. 5 is a flowchart showing a control operation of the degree of stereo separation of the FM radio receiving apparatus of the embodiment 3 in accordance with the present invention; and

FIG. 6 is a block diagram showing a configuration of an FM radio receiving apparatus of an embodiment 4 in accordance with the present invention.

### EMBODIMENTS FOR CARRYING OUT THE INVENTION

The best mode for carrying out the invention will now be described with reference to the accompanying drawings to explain the present invention in more detail.

### Embodiment 1

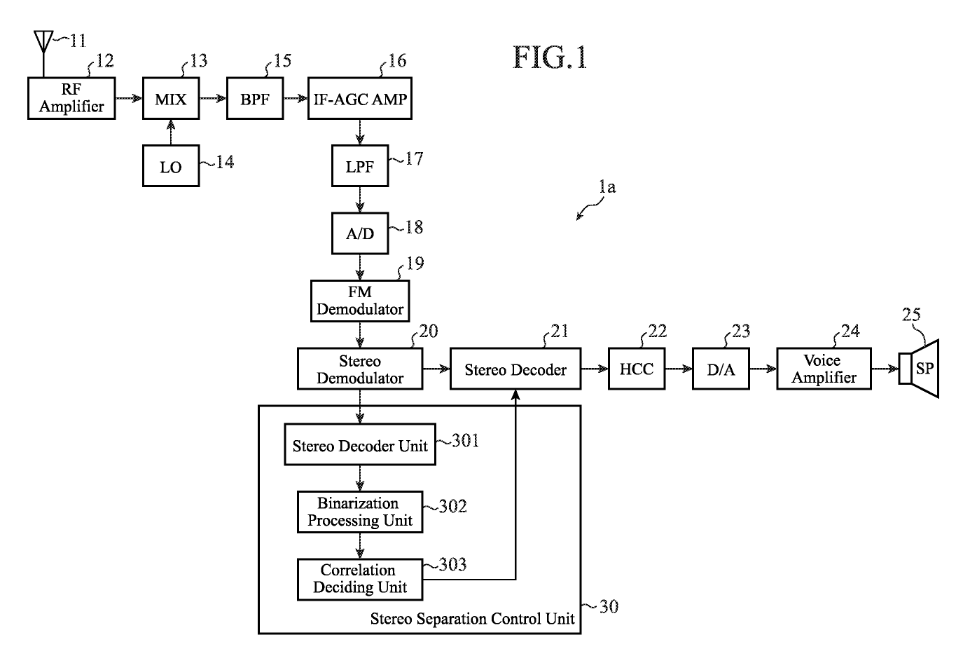

FIG. 1 is a block diagram showing a configuration of an

FM radio receiving apparatus of an embodiment 1 in accordance with the present invention. As shown in FIG. 1, the FM radio receiving apparatus 1a of the embodiment 1 comprises an antenna 11, an RF (Radio Frequency) amplifier 12, a frequency converter (MIX) 13, a local oscillator (LO) 14, an intermediate frequency filter (BPF) 15, a limiter intermediate frequency amplifier (IF-AGC AMP) 16, a pre-filter (LPF) 17, an analog-digital converter (A/D) 18, an FM demodulator 19, a stereo demodulator 20, a stereo decoder 21, a low-pass filter processing unit (HCC: high-cut control) 22, a digital-analog converter (D/A) 23, a voice amplifier 24, a speaker (SP) 25, and a stereo separation control unit 30.

In the arrangement shown in FIG. 1, an FM broadcast wave received with the antenna 11 is amplified by the RF amplifier 12, followed by frequency conversion by the frequency converter 13 and removal of an unnecessary component such as an adjacent channel wave through the intermediate frequency filter 15. Then, the FM broadcast wave passing through the intermediate frequency filter 15 undergoes an amplitude limit by the limiter intermediate frequency amplifier 16, followed by removal of a high-frequency component of the intermediate frequency through the pre-filter 17 and conversion to a digital signal by the analog-digital converter 18. The FM broadcast wave (referred to as a “digital FM wave” from now on) converted to a digital signal by the analog-digital converter 18 undergoes FM demodulation by the FM demodulator 19, followed by stereo demodulation by the stereo demodulator 20 and separation to left (L) and right (R) stereo voice signals by the stereo decoder 21. After that, the low-pass filter processing unit 22 filters off high-frequency signal component, the digital-analog converter 23 converts to an analog voice signal, and the voice amplifier 24 supplies it to the speaker 25.

The digital FM wave passing through the FM demodulation by the stereo demodulator 20 is supplied not only to the stereo decoder 21 described above, but to the stereo separation control unit 30. The stereo separation control unit 30 has functions of separating the stereo demodulation signal output from the stereo demodulator 20 into voice signals of the individual channels, binarizing the individual voice signals of the channels separated, storing the binarized voice signals of the individual channels for a prescribed time period, and deciding the correlation from the stored voice signals of the individual channels. The stereo separation control unit 30, which is realized by a microcomputer, for example, achieves the functions described above by a CPU which sequentially reads and executes a program recorded in the internal memory thereof. As for the structure of the program, it can be developed in terms of functions into a stereo decoder unit 301, a binarization processing unit 302 and a correlation deciding unit 303.

The stereo decoder unit 301 has a function of separating the digital FM wave passing through the demodulation fed from the stereo demodulator 20 into LR voice signals of individual channels through matrix processing, for example, and supplies them to the binarization processing unit 302. The binarization processing unit 302 has a function of binarizing the LR voice signals separated by the stereo decoder unit 301 by comparing them with a threshold and supplying to the correlation deciding unit 303. The correlation deciding unit 303 stores the LR voice signals binarized by the binarization processing unit 302 into a memory not shown for a prescribed time period and decides the correlation between the LR voice signals from the stored voice signals of the individual channels. Furthermore, the correlation deciding unit 303 has a function of controlling the degree of stereo separation when the stereo decoder 21 separates the digital FM wave into stereo signals in accordance with the correlation decided.

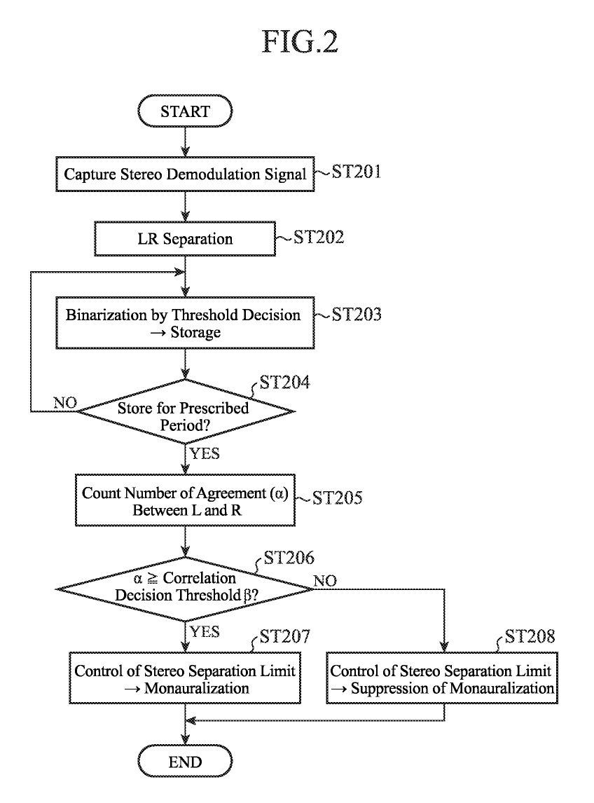

FIG. 2 is a flowchart showing the control operation of the degree of stereo separation of the FM radio receiving apparatus 1a of the embodiment 1 in accordance with the present invention.

Referring to FIG. 2, the operation of the FM radio receiving apparatus 1a of the embodiment 1 shown in FIG. 1 will now be described in detail.

In FIG. 2, the stereo separation control unit 30 captures the digital FM wave (stereo demodulation signal) passing through the demodulation by the stereo demodulator 20, and starts the stereo decoder unit 301 (step ST201). The stereo decoder unit 301 separates the stereo demodulation signal captured into the LR voice signals through the matrix processing and supplies them to the binarization processing unit 302 (step ST202). The binarization processing unit 302 binarizes the LR voice signals by comparing with a predetermined threshold, respectively, and stores in the internal memory (step ST203). Incidentally, as for the LR signals binarized, to avoid an uncomfortable feeling due to frequent fluctuations in the degree of separation in connection with the radio wave environment which will be described later, they are assumed to be stored for a prescribed time period.

When the internal memory described above stores the binarized LR signals for the prescribed time period (“YES” at step ST204), the correlation deciding unit 303 counts the number of agreement between the L signal and R signal (step ST205). Next, the correlation deciding unit 303 decides the correlation between the LR signals by comparing the number of agreement a counted with a predetermined correlation decision threshold (number of agreement β) (step ST206). If the correlation deciding unit 303 decides that the number of agreement between the L signal and R signal after the LR separation is not less than a correlation decision threshold (α≧β) (“YES” at step ST206), the stereo decoder 21 controls the degree of stereo separation toward monauralization when making the LR separation of the stereo demodulation signal supplied (step ST207). In contrast, if the correlation deciding unit 303 decides that the number of agreement a between the L signal and R signal after the LR separation is less than the correlation decision threshold β (α<β) (“NO” step ST206), the stereo decoder 21 controls the degree of stereo separation toward suppression of monauralization when making the LR separation of the stereo demodulation signal supplied (step ST208).

The FM radio receiving apparatus 1a of the embodiment 1 described above is configured in such a manner that after the stereo demodulator 20 carries out the stereo demodulation, the stereo separation control unit 30 causes the stereo decoder unit 301 to separate the LR voice signals and the correlation deciding unit 303 to count the number of agreement between the LR signals which are binarized and stored for the prescribed time period, thereby deciding the correlation between the LR signals. As a result, it is immune to noise occurring suddenly as compared with the conventional example which uses the signal level, thereby enabling more accurate correlation detection with reference to an actual acoustic feeling. In addition, by placing a stronger limit on the degree of stereo separation with an increase of the correlation between channels, it can reduce undesirable effects of impairing presence of stereo, thereby being able to carry out appropriate control that adjusts the balance between the stereo noise suppression and presence of stereo. Furthermore, by making a correlation decision after binarizing the LR voice signals, it can considerably reduce the capacity of the memory required and the circuit scale as compared with the conventional example that makes the correlation decision from the signal levels.

### Embodiment 2

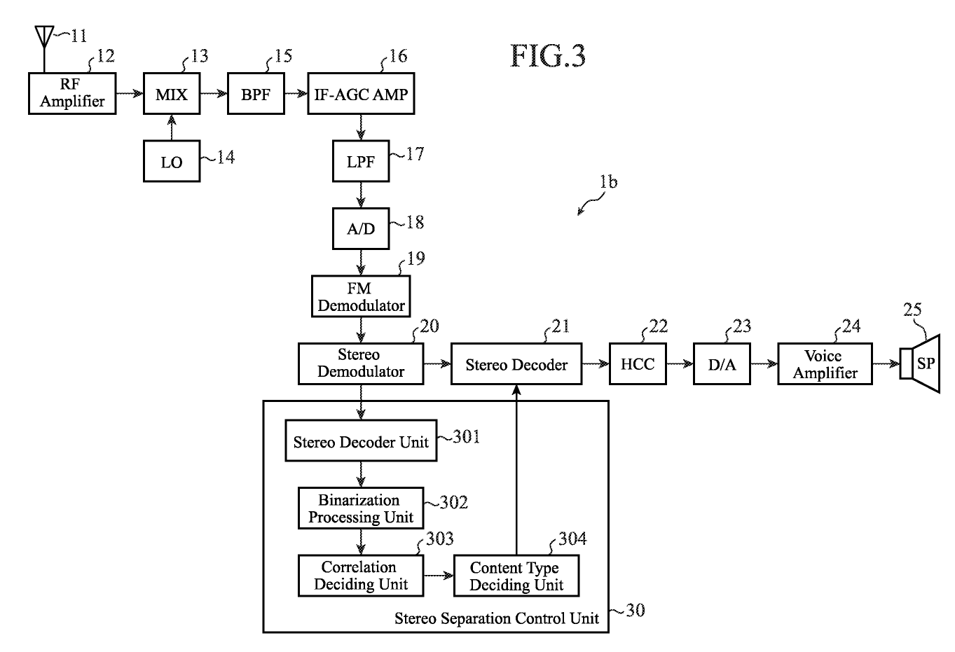

FIG. 3 is a block diagram showing a configuration of an FM radio receiving apparatus 1b of an embodiment 2 in accordance with the present invention. In FIG. 3, the configuration differs from the embodiment 1 shown in FIG. 1 in that a content type deciding unit 304 is added to the stereo separation control unit 30 so that the output of the content type deciding unit 304 controls the degree of separation between the right and left channels made by the stereo decoder 21. The remaining configuration is the same as that of the FM radio receiving apparatus 1a of the embodiment 1 shown in FIG. 1.

The content type deciding unit 304 has a function of deciding the type of the received contents in accordance with the correlation decided by the correlation deciding unit 303. As for the type decision of the contents, in the same manner as the embodiment 1 described above, the correlation deciding unit 303 counts the number of agreement a after the LR separation and produces the correlation by comparing it with the correlation decision threshold β, and the content type deciding unit 304 decides that when the correlation (the number of agreement) is large for the prescribed period, the contents are those like “news” which do not require presence of stereo so much, and that when the correlation is small for the prescribe period, the contents are those which require presence of stereo such as “music”. According to the decision result, the stereo decoder 21 controls the LR separation.

According to the FM radio receiving apparatus 1b of the embodiment 2 described above, the content type deciding unit 304 decides the type of the received contents in accordance with the correlation the correlation deciding unit 303 decides, and the stereo decoder 21 controls the degree of separation of the stereo signals according to the type of the contents decided. When the content type deciding unit 304 decides that the contents are those like news which do not require presence of stereo so much as music, it tries monauralization positively. In contrast, when it decides that the contents are those that require presence of stereo such as music, it suppresses the monauralization. Thus, it can provide the FM radio receiving apparatus 1b capable of appropriate control that adjusts the balance between the stereo noise suppression and presence of stereo in accordance with the contents.

### Embodiment 3

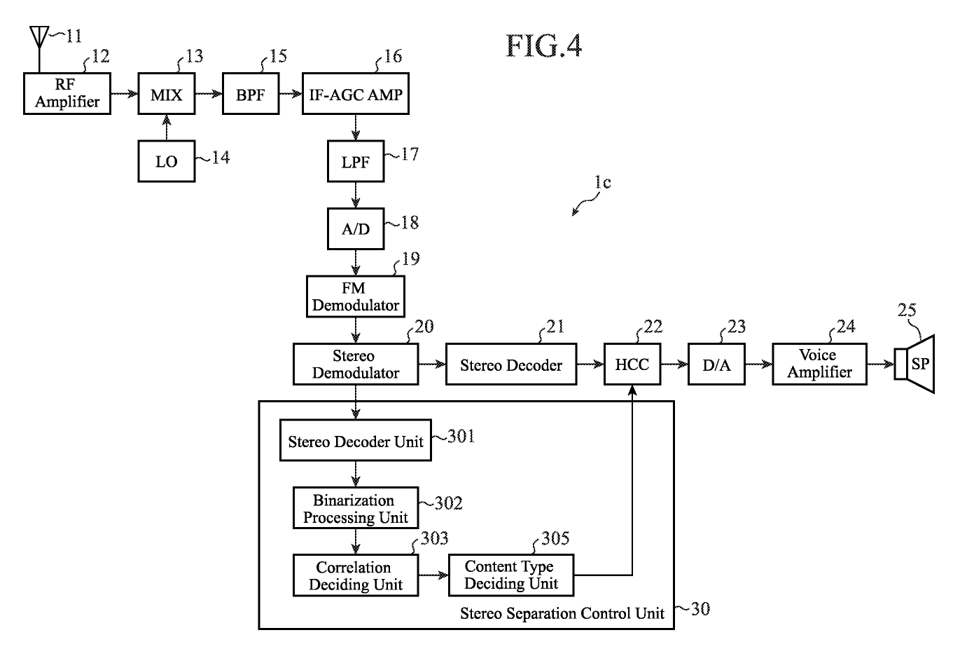

FIG. 4 is a block diagram showing a configuration of an FM radio receiving apparatus 1c of an embodiment 3 in accordance with the present invention. In FIG. 4, the configuration differs from the embodiment 1 shown in FIG. 1 in that a content type deciding unit 305 is added to the stereo separation control unit 30 so that the output of the content type deciding unit 305 controls the cutoff frequency fc of the low-pass filter processing unit (HCC: high-cut control) 22. The remaining configuration is the same as that of the FM radio receiving apparatus 1a of the embodiment 1.

The content type deciding unit 305 has a function of deciding the type of the received contents in accordance with the correlation decided by the correlation deciding unit 303. In addition, the content type deciding unit 305 can decide that when the correlation is small for the prescribed period, the contents are those that require the quality of sound such as music, and that when the correlation is large, the contents are those that do not require the quality of sound such as news. According to the type of the contents decided by the content type deciding unit 305, the low-pass filter processing unit 22 controls the cutoff frequency fc of the low-pass filter. More specifically, when the content type deciding unit 305 makes a decision that the contents are music, the low-pass filter processing unit 22 suppresses a decrease of the cutoff frequency fc to maintain the quality of sound to a certain level because music is considered to include a lot of high-frequency components. In contrast, when it makes a decision that the contents are news, the low-pass filter processing unit 22 decreases the cutoff frequency fc positively because news is considered to include a comparatively small amount of high-frequency components.

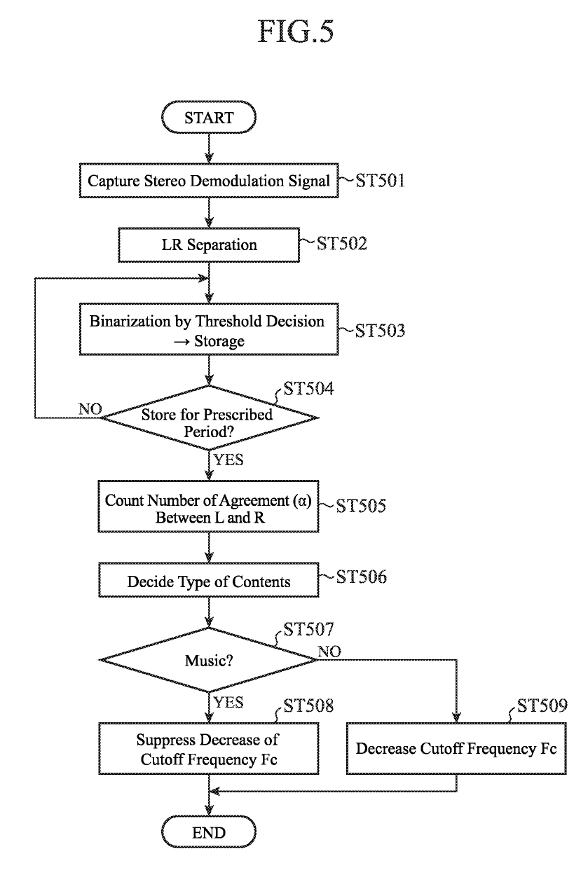

FIG. 5 is a flowchart showing the control operation of the degree of stereo separation of the FM radio receiving apparatus 1c of the embodiment 3 in accordance with the present invention. Referring to FIG. 5, the operation of the FM radio receiving apparatus 1c of the embodiment 3 shown in FIG. 4 will now be described in detail.

In FIG. 5, since the operation from the step (step ST501), at which the stereo separation control unit 30 captures the digital FM wave (stereo demodulation signal) demodulated by the stereo demodulator 20 and starts the stereo decoder unit 301, up to the step (step ST505), at which the correlation deciding unit 303 counts the number of agreement a between the LR signals, is the same as the operation of steps ST201-ST205 of the embodiment 1, the description thereof will be omitted to avoid duplication.

In the embodiment 3, according to the correlation delivered from the correlation deciding unit 303, the content type deciding unit 305 decides the type of the contents (step ST506). When the correlation is small for the prescribed period, the content type deciding unit 305 decides that the contents are those that require the quality of sound like music (“YES” at step ST507). Since music includes a lot of high-frequency components compared with news or the like, the low-pass filter processing unit 22 carries out control of suppressing a decrease of the cutoff frequency fc and maintaining the quality of sound (step ST508). In contrast, when the correlation is large for the prescribed period, the content type deciding unit 305 decides that the contents are those like news that do not require the quality of sound so much (“NO” at step ST507). Since news includes comparatively a small quantity of high-frequency components, the low-pass filter processing unit 22 carries out control of decreasing the cutoff frequency fc positively in accordance with the decision result (step ST509).

According to the FM radio receiving apparatus 1c of the embodiment 3 described above, the content type deciding unit 305 decides the type of the received contents in accordance with the correlation the correlation deciding unit 303 decides, and the low-pass filter processing unit 22 controls the cutoff frequency fc according to the type of the contents decided. Thus, when it decides that the contents are those like news that do not require the quality of sound so much, it tries noise suppression by attenuating the high-frequency components by decreasing the cutoff frequency fc, but when it decides that the contents are those that require the quality of sound like music, it maintains the quality of sound by suppressing a decrease of the cutoff frequency fc. This makes it possible to provide the FM radio receiving apparatus 1c capable of carrying out appropriate control that adjusts the balance between the stereo noise suppression and the quality of sound in accordance with the contents.

### Embodiment 4

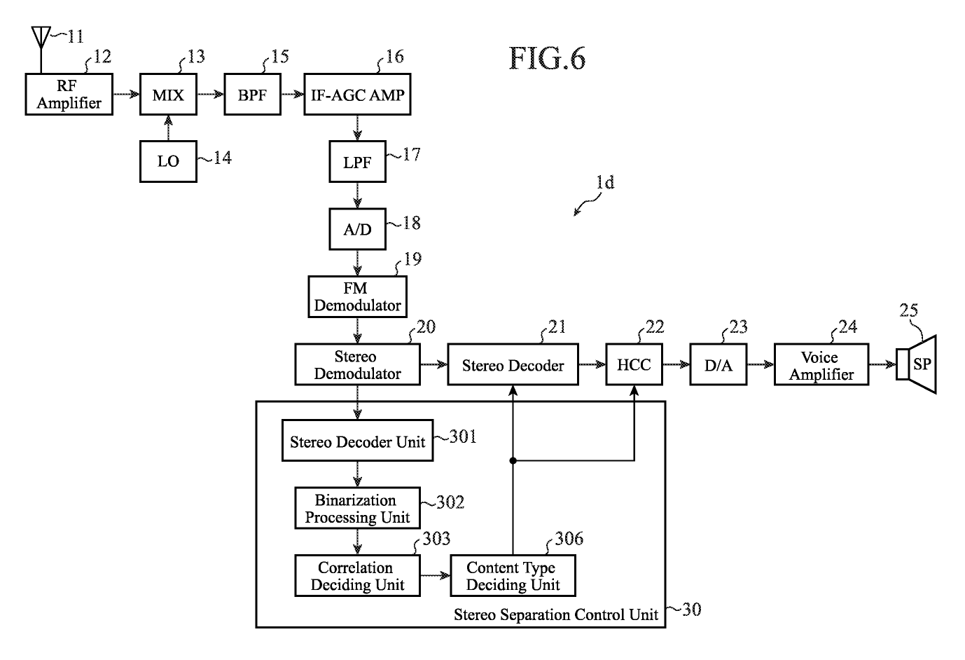

FIG. 6 is a block diagram showing a configuration of an FM radio receiving apparatus 1d of an embodiment 4 in accordance with the present invention. In FIG. 6, the configuration differs from the embodiment 1 shown in FIG. 1 in that a content type deciding unit 306 is added to the stereo separation control unit 30 so that the output of the content type deciding unit 306 controls the degree of stereo separation of the stereo decoder 21 and the cutoff frequency fc of the low-pass filter processing unit 22. The remaining configuration is the same as that of the FM radio receiving apparatus 1a of the embodiment 1.

The content type deciding unit 306 has a function of deciding the type of the received contents in accordance with the correlation decided by the correlation deciding unit 303. The low-pass filter processing unit 22 has a function of controlling the cutoff frequency fc of the low-pass filter in accordance with the type of the contents decided by the content type deciding unit 306.

The content type deciding unit 306 decides, when the correlation is large for the prescribed period, for example, that the contents are those like news that do not require presence of stereo so much, and decides, when the correlation is small for the prescribed period, that the contents are those that require presence of stereo like music. The stereo decoder 21 controls the degree of separation of the stereo signals in accordance with the decision result of the type of the contents. Furthermore, when the content type deciding unit 306 decides that the content type is music, since the music is considered to have a comparatively lot of high-frequency components, the low-pass filter processing unit 22 suppresses the decrease of the cutoff frequency fc of the low-pass filter to maintain the quality of sound. In contrast, when it decides that the content type is news, since the news is considered to have a smaller quantity of high-frequency components than music, it carries out control of decreasing the cutoff frequency fc positively.

According to the FM radio receiving apparatus ld of the embodiment 4 described above, the content type deciding unit 306 decides the type of received contents in accordance with the correlation the correlation deciding unit 303 decides, the stereo decoder 21 controls the degree of separation of the stereo signals in accordance with the type of the contents decided, and the low-pass filter processing unit 22 controls the cutoff frequency of the low-pass filter in accordance with the type of the contents decided. This makes it possible to provide the FM radio receiving apparatus ld capable of achieving appropriate control that adjusts the balance between the stereo noise suppression and the presence and quality of sound in accordance with the contents. For example, when it decides that the contents are those like news, which do not require presence of right and left or the quality of sound so much as music, it carries out control in such a manner as to try monauralization positively and to decrease the cutoff frequency fc. In contrast, when it decides that the contents are those like music, it carries out control in such a manner as to suppress monauralization and reduction in the cutoff frequency fc. Thus, it can enable appropriate control that adjusts the balance among the stereo noise suppression, presence of stereo and the quality of sound.

Incidentally, as for the functions of the stereo separation control unit 30 in the foregoing embodiments 1, 2, 3 and 4, all of them can be realized by software, or at least part of them can be realized by hardware. For example, as for the data processing of the stereo separation control unit 30, which separates the stereo signals into voice signals of the individual channels, binarizes the individual voice signals of the channels separated, stores the binarized voice signals of the individual channels for a prescribed time period, decides the correlation of the voice signals of the individual channels stored, and controls the degree of separation of the stereo signals in accordance with the correlation, it can be realized by one or more programs on a computer, or at least part of it can be realized by hardware.

### INDUSTRIAL APPLICABILITY

The FM radio receiving apparatus (1a, 1b, 1c, 1d) in accordance with the present invention separates a stereo signal of the FM stereo broadcasting wave received into voice signals of individual channels, binarizes the individual voice signals of the channels separated, stores the binarized voice signals of the individual channels for a prescribed time period, decides correlation of the voice signals between the channels from the voice signals of the individual channels stored, and controls the degree of separation of the individual channels of the stereo signal in accordance with the correlation decided. Thus, it can suppress an undesirable effect of impairing presence of stereo by placing a stronger limit on the degree of stereo separation as the correlation between channels increases, for example. In addition, since it makes the correlation decision after storing the voice signals of the individual channels passing through the binarization after the stereo separation for the prescribed time period, it can reduce the memory capacity required for the storage of the stereo signal and increase the accuracy of the correlation detection. As a result, it can offer a marked advantage when applied to a mobile unit including an onboard apparatus whose radio wave environment fluctuates moment by moment.

What is claimed is:

1. An FM radio receiving apparatus for receiving an FM stereo broadcasting wave, comprising:
a stereo decoder unit for separating a stereo signal of the FM stereo broadcasting wave received into voice signals of individual channels;
a binarization processing unit for binarizing the individual voice signals of the channels separated by the stereo decoder unit; and
a correlation deciding unit for storing the voice signals of the individual channels binarized by the binarization processing unit for a prescribed time period, and for deciding correlation of the voice signals between the channels from the voice signals of the individual channels stored, wherein
the FM radio receiving apparatus controls the degree of separation of the individual channels of the stereo signal in accordance with the correlation decided by the correlation deciding unit.

2. An FM radio receiving apparatus for receiving an FM stereo broadcasting wave, comprising:
a stereo decoder unit for separating a stereo signal of the FM stereo broadcasting wave received into voice signals of individual channels;
a binarization processing unit for binarizing the individual voice signals of the channels separated by the stereo decoder unit;
a correlation deciding unit for storing the voice signals of the individual channels binarized by the binarization processing unit for a prescribed time period, and for deciding correlation of the voice signals between the channels from the voice signals of the individual channels stored; and
a content type deciding unit for deciding a type of received contents in accordance with the correlation decided by the correlation deciding unit, wherein
the FM radio receiving apparatus controls the degree of separation of the individual channels of the stereo signal in accordance with the type of the received contents decided by the content type deciding unit.

3. An FM radio receiving apparatus for receiving an FM stereo broadcasting wave, comprising:
a stereo decoder unit for separating a stereo signal of the FM stereo broadcasting wave received into voice signals of individual channels;
a binarization processing unit for binarizing the individual voice signals of the channels separated by the stereo decoder unit;
a correlation deciding unit for storing the voice signals of the individual channels binarized by the binarization processing unit for a prescribed time period, and for deciding correlation of the voice signals between the channels from the voice signals of the individual channels stored; and
a content type deciding unit for deciding a type of received contents in accordance with the correlation decided by the correlation deciding unit, wherein
the FM radio receiving apparatus controls, in accordance with the type of the received contents decided by the content type deciding unit, a cutoff frequency of a low-pass filter unit for filtering off a high-frequency component of the stereo signal that is separated into the individual channels.

4. The FM radio receiving apparatus according to claim 2, which controls, in accordance with the type of the received contents decided by the content type deciding unit, a cutoff frequency of a low-pass filter unit for filtering off a high-frequency component of the stereo signal that is separated into the individual channels.
